(19) United States
(12) Patent Application Publication
(10) Pub. No.: US 2018/0024993 A1
(43) Pub. Date: Jan. 25, 2018

(54) COMPUTER-READABLE RECORDING MEDIUM, DETERMINATION DEVICE AND DETERMINATION METHOD

(71) Applicant: FUJITSU LIMITED, Kawasaki-shi (JP)

(72) Inventors: Naohiro Itou, Numazu (JP); Nobuko Takase, Mizuho (JP); Kazuo Mineno, Inagi (JP)

(73) Assignee: FUJITSU LIMITED, Kawasaki-shi (JP)

(21) Appl. No.: 15/624,361

(22) Filed: Jun. 15, 2017

(30) Foreign Application Priority Data
Jul. 25, 2016 (JP) 2016-145682

(51) Int. Cl. G06F 17/27; G06F 17/28

(52) U.S. Cl. CPC G06F 17/2795; G06F 17/2735; G06F 17/2755; G06F 17/279; G06F 17/274; G06F 17/2863

(57) ABSTRACT

An information processing device receives sentence data. The information processing device generates sets of information, each of the sets indicating a relationship between each of words included in the received sentence data and another word among the words by executing a semantic analysis process on the words. The information processing device determines a similarity between the words based on a similarity between the generated the sets of information. The information processing device outputs a result of the determining.

### CROSS-REFERENCE TO RELATED APPLICATION(S)

This application is based upon and claims the benefit of priority of the prior Japanese Patent Application No. 2016-145682, filed on Jul. 25, 2016, the entire contents of which are incorporated herein by reference.

### FIELD

The embodiment discussed herein is related to a determination program, or the like.

### BACKGROUND

For documents, such as manuals, articles, or design documents, for which logical consistency is needed, there is a need to use the same expression for the ones that represent the same meaning and the different expressions for the ones that represent the different meaning. Therefore, when documents are polished, it is checked whether different expressions are used to represent the same meaning or the same expression is used to represent different meanings. Different expressions that represent the same meaning are called “synonymous words”. The same expression that represent different meanings are called “polysemous words”.

During a process to check whether synonyms are not used, the list of synonyms is used as a dictionary (synonym dictionary) to check whether, for example, two words are the words that are described in the synonym dictionary. The synonym dictionary includes, for example, general-use dictionaries, dictionaries that are specialized in the field that is described in the target document, or dictionaries that are specialized in the contents (e.g., product) of the target document.

General-use synonym dictionaries or synonym dictionaries that are specialized in the field that is described in the target document are provided as books or electronic media. However, as the provided synonym dictionaries are not the dictionaries that are specialized in the contents of the target document, they are sometimes not sufficient as the synonym dictionary that is specialized in the contents of the target document. Thus, there is a need to previously generate a synonym dictionary that is specialized in the contents of the target document.

Here, there is a disclosed technology (for example, see Japanese Laid-open Patent Publication No. 2012-73951) in which, during a process to compare character strings, two character strings are compared in consideration of the semantic contents of the character strings. According to this technology, with regard to a first character string and a second character string that are the targets to be compared, the words that have the common semantic attribute, which represents the semantic characteristics that are possessed by each word, are identified, the words that have the common semantic attribute are compared, and in accordance with a comparison result, the comparison result of the first character string and the second character string is generated. Specifically, during the process to compare the character strings, with regard to the character strings that are compared with each other, comparison results are generated such that the character strings are matched if the semantic contents, possessed by the character strings, are the same although their expressions are different. Here, examples of the semantic attribute include the belongingness, address, or personal name.

### SUMMARY

According to an aspect of an embodiment, a non-transitory computer-readable recording medium has stored therein a program that causes a computer to execute a process. The process includes receiving sentence data. The process includes generating sets of information, each of the sets indicating a relationship between each of words included in the received sentence data and another word among the words by executing a semantic analysis process on the words. The process includes determining a similarity between the words based on a similarity between the generated the sets of information. The process includes outputting a result of the determining.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram that illustrates an example of the configuration of an information processing device according to an embodiment;

FIG. 2A is a diagram (1) that illustrates an example of an idea structure;

FIG. 2B is a diagram (2) that illustrates an example of the idea structure;

FIG. 2C is a diagram (3) that illustrates an example of the idea structure;

FIG. 3 is a diagram that illustrates an example of the arc symbol;

FIG. 4A is a diagram that illustrates an example of a first synonym candidate;

FIG. 4B is a diagram that illustrates an example of a second synonym candidate;

FIG. 5 is a diagram (1) that illustrates the flow of a first synonym-candidate extraction process according to the embodiment;

FIG. 6 is a diagram (2) that illustrates the flow of the first synonym-candidate extraction process according to the embodiment;

FIG. 7 is a diagram (3) that illustrates the flow of the first synonym-candidate extraction process according to the embodiment;

FIG. 8 is a diagram (1) that illustrates the flow of a second synonym-candidate extraction process according to the embodiment;

FIG. 9 is a diagram (2) that illustrates the flow of the second synonym-candidate extraction process according to the embodiment;

FIG. 10 is a diagram (3) that illustrates the flow of the second synonym-candidate extraction process according to the embodiment;

FIG. 11 is a diagram (1) that illustrates an example of the flowchart of the first synonym-candidate extraction process according to the embodiment;

FIG. 12 is a diagram (2) that illustrates an example of the flowchart of the first synonym-candidate extraction process according to the embodiment;

FIG. 13 is a diagram (3) that illustrates an example of the flowchart of the first synonym-candidate extraction process according to the embodiment;

FIG. 14 is a diagram (4) that illustrates an example of the flowchart of the first synonym-candidate extraction process according to the embodiment;

FIG. 15 is a diagram that illustrates an example of the data structures of a hash index and a synonym candidate list;

FIG. 16 is a diagram (5) that illustrates an example of the flowchart of the first synonym-candidate extraction process according to the embodiment;

FIG. 17 is a diagram (1) that illustrates an example of the flowchart of a second synonym-candidate extraction process according to the embodiment;

FIG. 18 is a diagram (2) that illustrates an example of the flowchart of the second synonym-candidate extraction process according to the embodiment;

FIG. 19 is a diagram (3) that illustrates an example of the flowchart of the second synonym-candidate extraction process according to the embodiment;

FIG. 20 is a diagram (4) that illustrates an example of the flowchart of the second synonym-candidate extraction process according to the embodiment;

FIG. 21 is a diagram (5) that illustrates an example of the flowchart of the second synonym-candidate extraction process according to the embodiment; and

FIG. 22 is a diagram that illustrates an example of the computer that executes a determination program.

### DESCRIPTION OF EMBODIMENT(S)

Preferred embodiments of the present invention will be explained with reference to accompanying drawings. Furthermore, in the embodiment, an explanation is given by using the determination device as an information processing device. The present invention is not limited to the embodiment.

There is a problem in that it is difficult to automatically generate synonym dictionaries that are specialized in the contents of the target document. For example, according to conventional technologies, there is a need to previously determine the semantic characteristics of each word to be compared, and if the semantic characteristics are not determined, it is difficult to determine whether the first character string and the second character string are synonymous with each other. Therefore, according to the conventional technologies, it is difficult to generate synonym dictionaries that are specialized in the contents of the target document.

### Configuration of the Information Processing Device According to the Embodiment

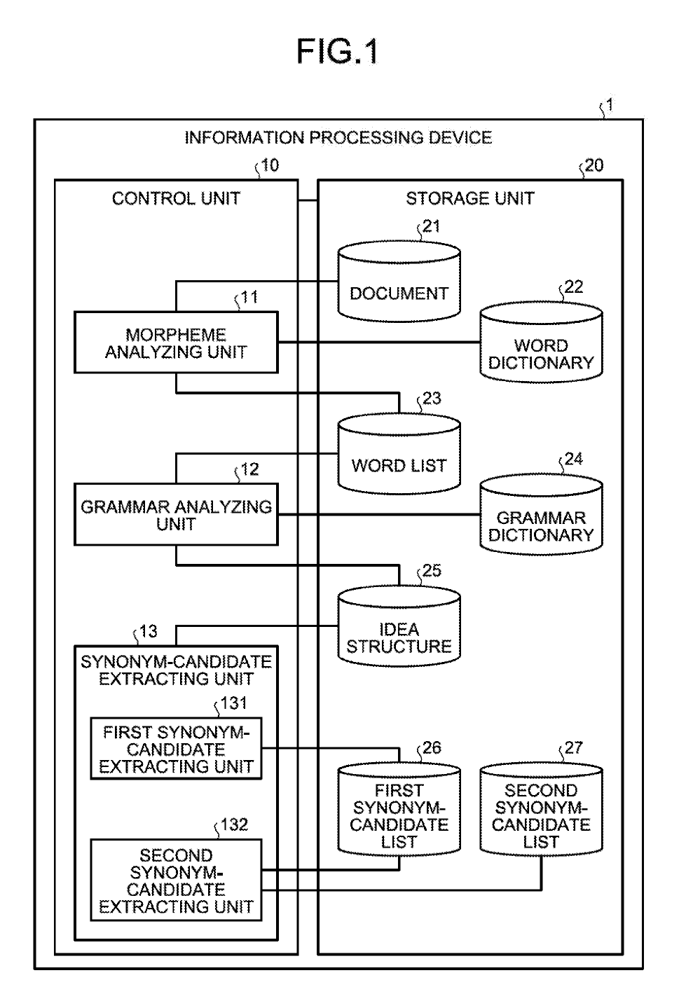

FIG. 1 is a functional block diagram that illustrates the configuration of an information processing device according to a first embodiment. An information processing device 1, illustrated in FIG. 1, uses results of a natural-language semantic analysis process, which is used for machine translations, or the like, to automatically extract different expressions that represent the same meaning. Different expressions that represent the same meaning are called “synonyms”. Furthermore, the “document” used in the embodiment means a set of sentences, of which terms, such as words, need to be unified, and it does not always need to include subjects or predicates. The “sentence” means a processing unit included in the “document”, and it is synonymous with “text”.

The information processing device 1 includes a control unit 10 and a storage unit 20.

The control unit 10 is equivalent to an electronic circuit, such as a central processing unit (CPU). Furthermore, the control unit 10 includes an internal memory that stores programs defining various procedures or control data, and it executes various processes by using them. The control unit 10 includes a morpheme analyzing unit 11, a grammar analyzing unit 12, and a synonym-candidate extracting unit 13.

The storage unit 20 is a semiconductor memory device, such as a RAM or a flash memory, or a storage device, such as a hard disk or an optical disk. The storage unit 20 has a document 21, a word dictionary 22, a word list 23, a grammar dictionary 24, an idea structure 25, a first synonym-candidate list 26, and a second synonym-candidate list 27.

The document 21 is the target document from which synonym candidates are extracted. The document 21 is for example the target document that contains sentences that are specialized in the contents of a product. Furthermore, although it is explained that the document 21 is the document that is specialized in the contents, this is not a limitation, and it may be a document that is specialized in any field, or it may be a general document.

The morpheme analyzing unit 11 conducts morpheme analysis on multiple sentences that are included in the target document. For example, the morpheme analyzing unit 11 sequentially reads sentence data on the target document from the document 21. Then, the morpheme analyzing unit 11 refers to the word dictionary 22 and divides the read sentence data in units of words. Then, the morpheme analyzing unit 11 stores the divided word in the word list 23.

The word dictionary 22 is the dictionary that relates, for example, the expression that corresponds to a word, the word class of the word, the semantic attribute possessed by the word, and the idea symbol of the word. The word list 23 is a list of words that are obtained as a result of analysis on sentence data by the morpheme analyzing unit 11.

The grammar analyzing unit 12 refers to the grammar dictionary 24 and generates the idea structure 25 that represents the meanings of the document 21 as a natural language. That is, the grammar analyzing unit 12 generates the idea structure 25 during a natural-language semantic analysis process. For example, the grammar analyzing unit 12 refers to the grammar dictionary 24 and, with regard to each word, included in words that are stored in the word list 23, generates the idea structure 25 that indicates the relationship between the word and a different word included in the words.

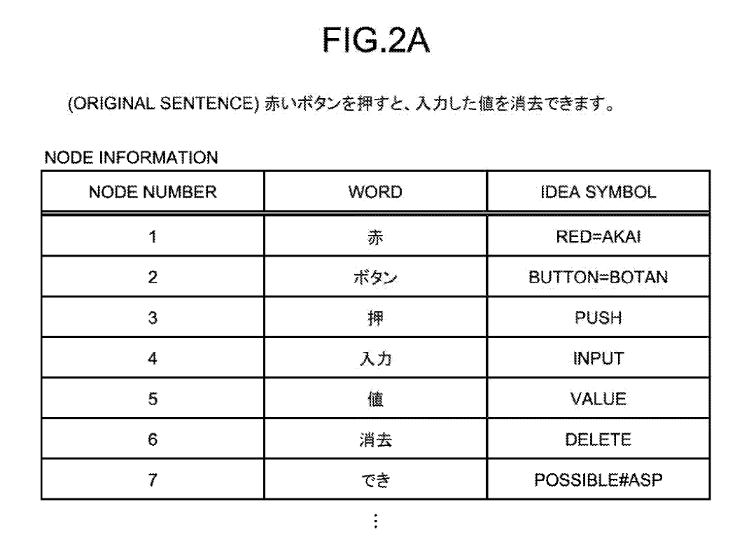

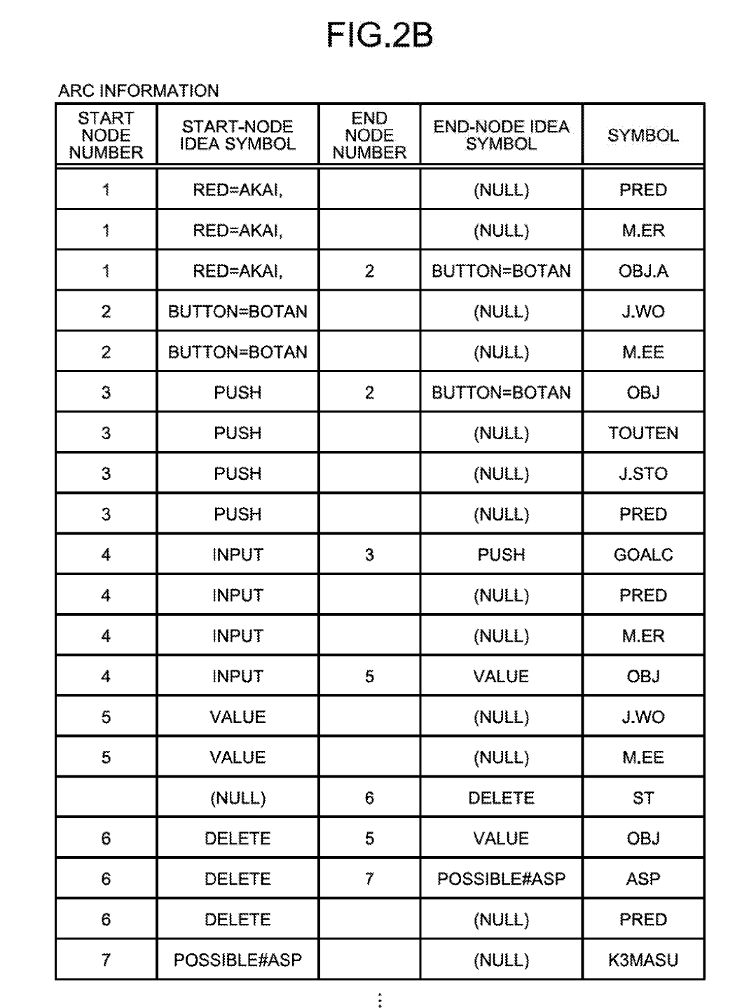

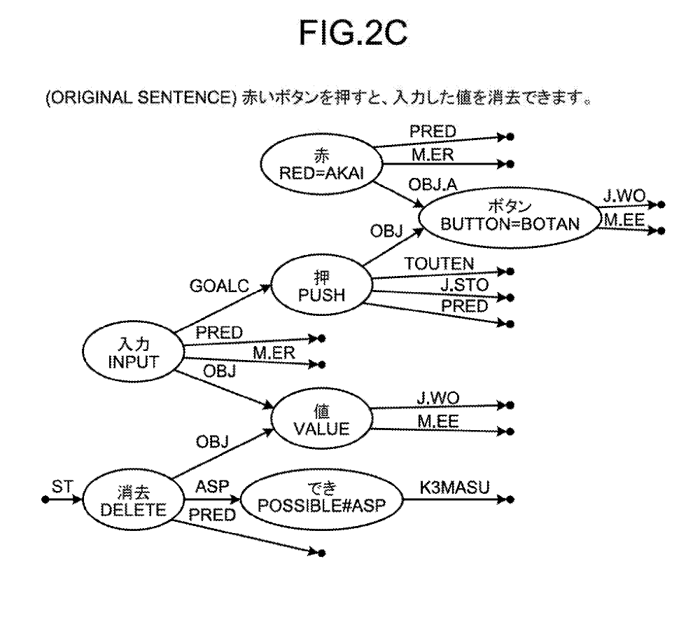

With reference to FIGS. 2A to 2C, an explanation is here given of an example of the idea structure 25. FIGS. 2A to 2C are diagrams that illustrate an example of the idea structure. FIG. 2A is a diagram that illustrates an example of the node information among the internal expressions of the idea structure 25, FIG. 2B is a diagram that illustrates an example of the arc information among internal expressions of the idea structure 25, and FIG. 2C puts the idea structure 25 into the form of a diagram.

As illustrated in FIGS. 2A and 2B, the idea structure 25 includes the original sentence, the node information, and the arc information. The original sentence is single sentence data on the target document from which synonym candidates are extracted. Here, it is assumed that the sentence data is “ [symbol] [symbol] ∘”. The node information includes information on node numbers, words, and idea symbols. The node number is the unique identification number for identifying a node. The word is an expression that indicates the range of a word when the sentence data is divided into words. The idea symbol is a symbol that identifies the idea that is represented by a word in terms of meanings (idea level). For example, the idea symbol of the word “ [symbol] ” is “RED=AKAI”, and the idea symbol of the word “ [symbol] ” is “BUTTON=BOTAN”. Here, the idea symbol of the word “ [symbol] ” is the same “RED=AKAI” as the idea symbol of the word “ [symbol] ”.

The arc information is information that represents the relationship between words. The arc information includes start node numbers, start-node idea symbols, end node numbers, end-node idea symbols, and symbols. The start node number and the end node number indicate the two target nodes that represent the relationship that is indicated by the symbol. The start node number and the end node number identify the word in the sentence data by using its own node idea symbol and node number. The symbol puts the relationship between two nodes into the form of a symbol. Furthermore, if any of the start node and the end node does not exist, the non-existent node is set NULL. This is used in the case where, for example, a function in sentence data is assigned to the word of the target node, and it is referred to as “characteristic” of the target node.

As illustrated in FIG. 2C, for example, the word “ [symbol] ” is represented by the idea symbol “RED=AKAI”. Furthermore, the node with the idea symbol “RED=AKAI” is connected to the word “ [symbol] ” with the arc that has the symbol “OBJ.A”. Furthermore, the node with the idea symbol “RED=AKAI” is connected to two arcs where a node does not exist on the other side. One of the arcs is the symbol “PRED”, and the other one of the arcs is the symbol “M.ER”. That is, the node has the characteristics “PRED, M.ER”. Furthermore, the word “ [symbol] ” is represented by the idea symbol “VALUE”. Furthermore, the node with the idea symbol “VALUE” is connected to the word “ [symbol] ” and the word “ [symbol] ” with the arc that has the symbol “OBJ”. Furthermore, the node with the idea symbol “VALUE” is connected to two arcs where a node does not exist on the other side. One of the arcs is the symbol “J.WO”, and the other one of the arcs is the symbol “M.EE”. That is, the node has the characteristics “J.WO, M.EE”. Thus, the idea structure 25 is represented by the directed graph that indicates the semantic relationship between words.

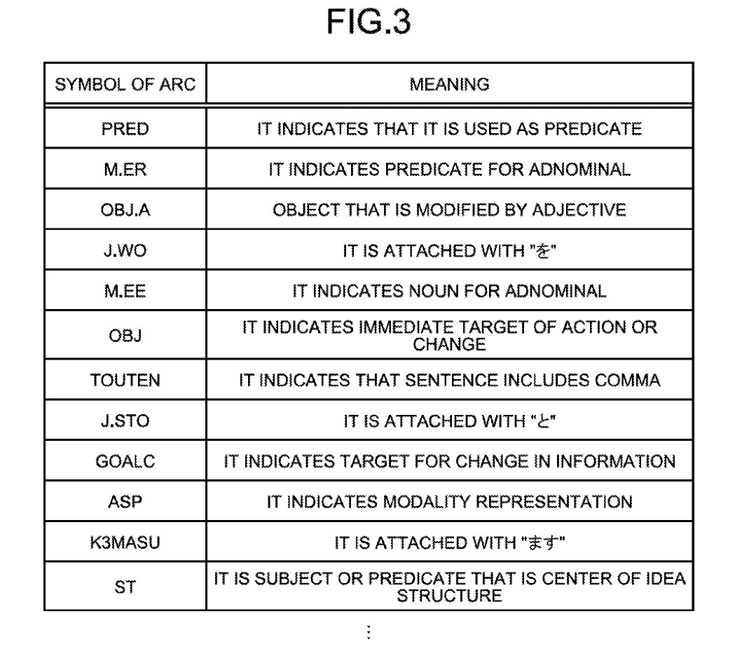

Here, with reference to FIG. 3, an example of the arc symbol is explained. FIG. 3 is a diagram that illustrates an example of the arc symbol.

As illustrated in FIG. 3, the arc symbol “OBJ.A” indicates that it is “the object that is modified by the adjective”. The node with the idea symbol “RED=AKAI”, illustrated in FIG. 2C, means that the word “ [symbol] ” is “the object that is modified by the adjective”, represented by “OBJ.A”. The node with the idea symbol “RED=AKAI” means that “it indicates that it is used as a predicate”, represented by “PRED”. The node with the idea symbol “RED=AKAI” means that “it indicates the predicate for adnominal”, represented by “M.ER”.

Furthermore, the arc symbol “OBJ” means “it indicates the immediate target of an action or change”. The node with the idea symbol “VALUE”, illustrated in FIG. 2C, means that “it indicates the immediate target of an action or change”, represented by “OBJ”, with regard to the node with the idea symbol “INPUT”. The node with the idea symbol “VALUE” means that “it indicates the immediate target of an action or change”, represented by “OBJ”, with regard to the node with the idea symbol “DELETE”. The node with the idea symbol “VALUE” means that “it is attached with “ [symbol] ””, represented by “J.WO”. The node with the idea symbol “VALUE” means that “it indicates the noun for adnominal”, represented by “M.EE”.

Furthermore, semantic analysis on sentences, performed by the grammar analyzing unit 12, is conducted by using the existing machine translation technologies. The semantic analysis may be conducted by using machine translation technologies that are disclosed in for example Japanese Laid-open Patent Publication No. 6-68160, Japanese Laid-open Patent Publication No. 63-136260, or Japanese Laid-open Patent Publication No. 4-372061. Furthermore, the idea structure 25 is disclosed in for example Japanese Laid-open Patent Publication No. 2012-73951.

On the basis of the similarity of the idea structure 25, the synonym-candidate extracting unit 13 makes determinations with respect to the similarity between words. Specifically, the synonym-candidate extracting unit 13 uses the idea structure 25 to extract synonym candidates for words. The synonym-candidate extracting unit 13 includes a first synonym-candidate extracting unit 131 and a second synonym-candidate extracting unit 132.

The first synonym-candidate extracting unit 131 extracts, as synonym candidates, two words that have the same relationship with a single word. For example, the first synonym-candidate extracting unit 131 refers to the idea structure 25, extracts the characteristics with regard to each node, and generates a node characteristics list. The first synonym-candidate extracting unit 131 refers to the generated node characteristics list and the idea structure 25 and adds, to the first synonym-candidate list 26, the partner node that is connected to the node that is represented by the idea symbol and the characteristics via the arc with the symbol. Then, the first synonym-candidate extracting unit 131 deletes the row, in which only one node is registered in the node list, from the first synonym-candidate list 26. The nodes that remain in the node list of the first synonym-candidate list 26 are synonym candidates.

The first synonym-candidate list 26 is the list of synonym candidates that are extracted by the first synonym-candidate extracting unit 131. The first synonym-candidate list 26 stores an idea symbol, characteristics, the symbol and the direction of an arc, and a node list in a related manner. The idea symbol is the idea symbol of a node, which is used to add the partner node to the node list. The characteristics are the characteristics that are possessed by the node, which is used to add the partner node to the node list. The symbol and the direction of an arc are the symbol and the direction of the arc to the node, which is used to add the partner node to the node list. The node list is the list of nodes that have a relationship with the node that is indicated by the idea symbol. The nodes included in the node list are synonym candidates.

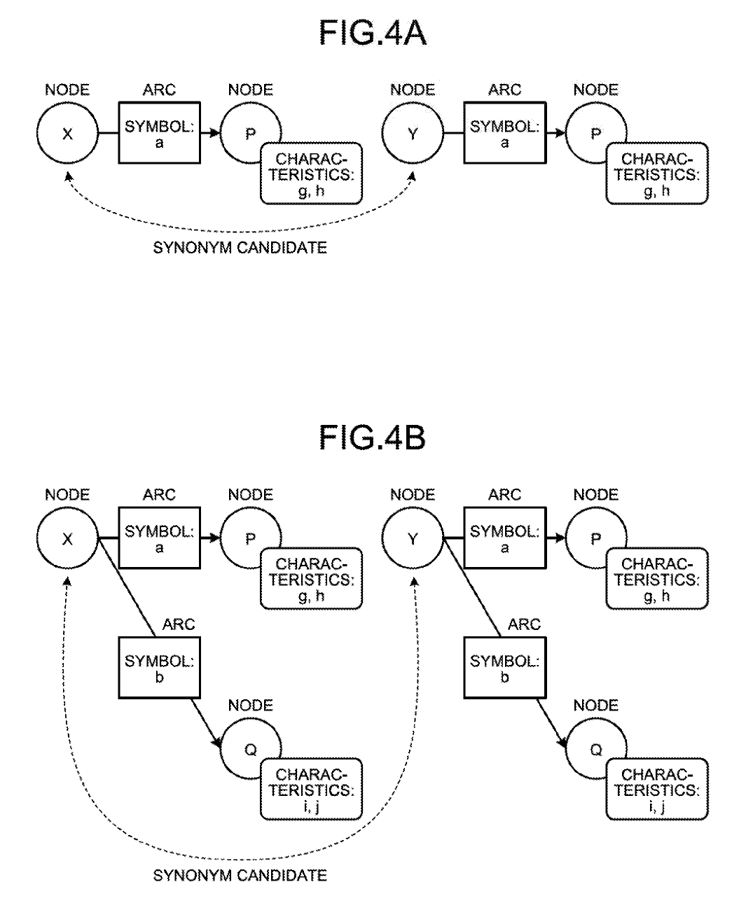

Here, with reference to FIG. 4A, an example of the first synonym candidate is explained. FIG. 4A is a diagram that illustrates an example of the first synonym candidate. As illustrated in FIG. 4A, the node of a word X has a relationship with the node of a word P that has characteristics g, h via the arc that has a symbol a. The node of a word Y has a relationship with the node of the word P, which has the characteristics g, h, via the arc that has the symbol a. In this case, both the node of the word X and the node of the word Y have a relationship with the word P that has the same idea symbol and the same characteristics g, h via the arc that has the same symbol a, and therefore the word X and the word Y are the same in relation to the word P. Specifically, as the idea structure 25 is a result of the conducted semantic analysis, it is assumed that there is a high possibility that the word X and the word Y are used for the same meaning. That is, the word X and the word Y are extracted as synonym candidates.

With reference back to FIG. 1, the second synonym-candidate extracting unit 132 extracts, as synonym candidates, two words that have the same relationship with two words. For example, the second synonym-candidate extracting unit 132 generates the reverse index that traces in reverse from each node, registered in the node list of the first synonym-candidate list 26, to the idea symbol. The second synonym-candidate extracting unit 132 uses the first synonym-candidate list 26 and the reverse index to extract two rows that include the same node as one pair. Then, the second synonym-candidate extracting unit 132 fetches two pairs that have the same relationship from the extracted pairs and extracts two nodes, included in each of the fetched two pairs, as synonym candidates. The same relationship means the relationship that has the same idea symbol, the same characteristics, and the same symbol and direction of the arc. Then, the second synonym-candidate extracting unit 132 stores the extracted node in the node list of the second synonym-candidate list 27.

Here, with reference to FIG. 4B, an example of the second synonym candidate is explained. FIG. 4B is a diagram that illustrates an example of the second synonym candidate. As illustrated in FIG. 4B, the node of the word X has a relationship with the node of the word P, which has the characteristics g, h, via the arc that has the symbol a, and it also has a relationship with the node of a word Q, which has characteristics i, j, via the arc that has a symbol b. The node of the word Y has a relationship with the node of the word P, which has the characteristics g, h, via the arc that has the symbol a, and it also has a relationship with the node of the word Q, which has the characteristics i, j, via the arc that has the symbol b. In such a case, both the node of the word X and the node of the word Y have a relationship with the word P, which has the same idea symbol and the same characteristics g, h, via the arc that has the same symbol a. In addition, the node of the word X and the node of the word Y have a relationship with the word Q, which has the same idea symbol and the same characteristics i, j, via the arc that has the same symbol b. Therefore, the word X and the word Y are the same in relation to the two words P, Q. As the idea structure 25 is a result of the conducted semantic analysis, it is assumed that there is a high possibility that the word X and the word Y are used for the same meaning. That is, the word X and the word Y are extracted as synonym candidates. Thus, the second synonym-candidate extracting unit 132 may extract synonym candidates with high accuracy as compared to synonym candidates that have a relationship with a single node.

Furthermore, extraction of synonym candidates that have the same relationship with k (k is a natural number larger than 2) words may be conducted in the same manner as the case where the second synonym-candidate list 27 is generated from the first synonym-candidate list 26. That is, the kth synonym-candidate extracting unit may generate a k synonym candidate list from a k−1 synonym candidate list. As k is larger, the kth synonym-candidate extracting unit may extract synonym candidates with higher accuracy.

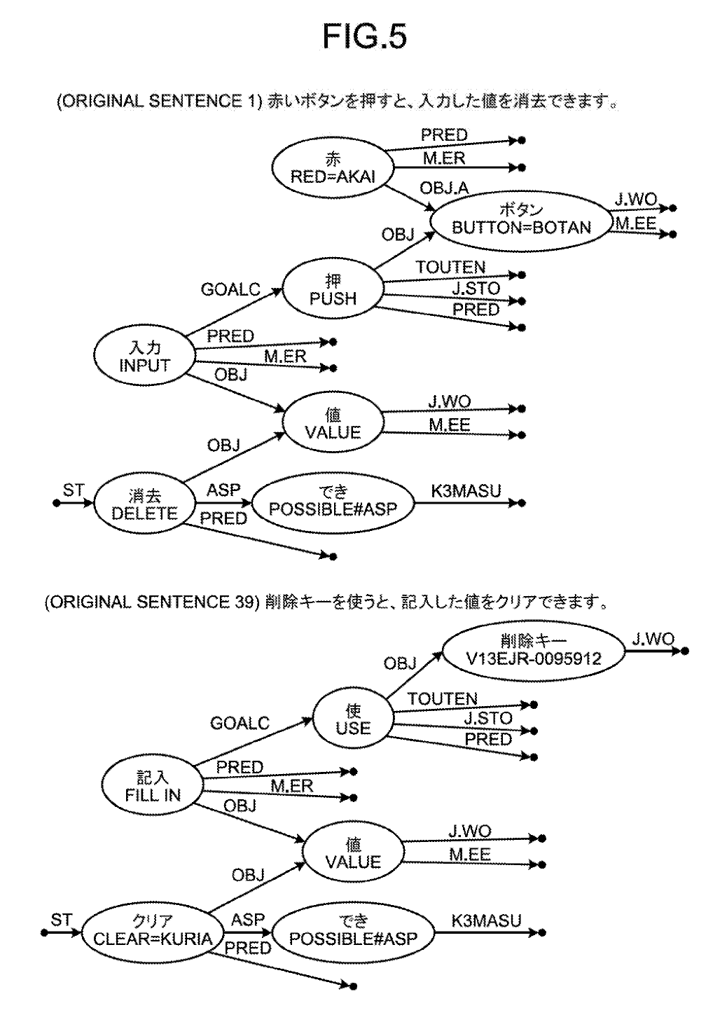

FIGS. 5 to 7 are diagrams that illustrate an example of a first synonym-candidate extraction process according to the embodiment.

As illustrated in FIG. 5, two sentences included in the target document are represented by the idea structure 25. Here, the sentence in the upper section is (the original sentence 1) “ [symbol] [symbol] ”, and the sentence in the lower section is (the original sentence 39) “ [symbol] [symbol] ”. The morpheme analyzing unit 11 performs morpheme analysis on each of the sentences and stores it in the word list 23. Then, the grammar analyzing unit 12 conducts semantic analysis on words, stored in the word list 23, to generate the idea structure 25.

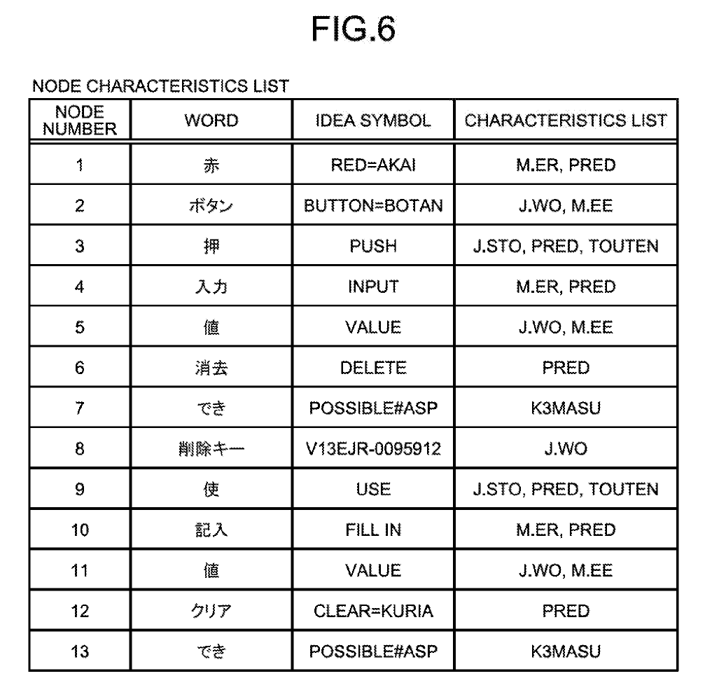

As illustrated in FIG. 6, the node characteristics list is represented. The first synonym-candidate extracting unit 131 refers to the idea structure 25, extracts the characteristics with regard to each node, and generates the node characteristics list. Here, for example, the first synonym-candidate extracting unit 131 extracts “M.ER, PRED” as the characteristics with regard to the node number “1” and sets it in the characteristics list. For example, the first synonym-candidate extracting unit 131 extracts “J.WO, M.EE” as the characteristics with regard to the node number “2” and sets it in the characteristics list of the node.

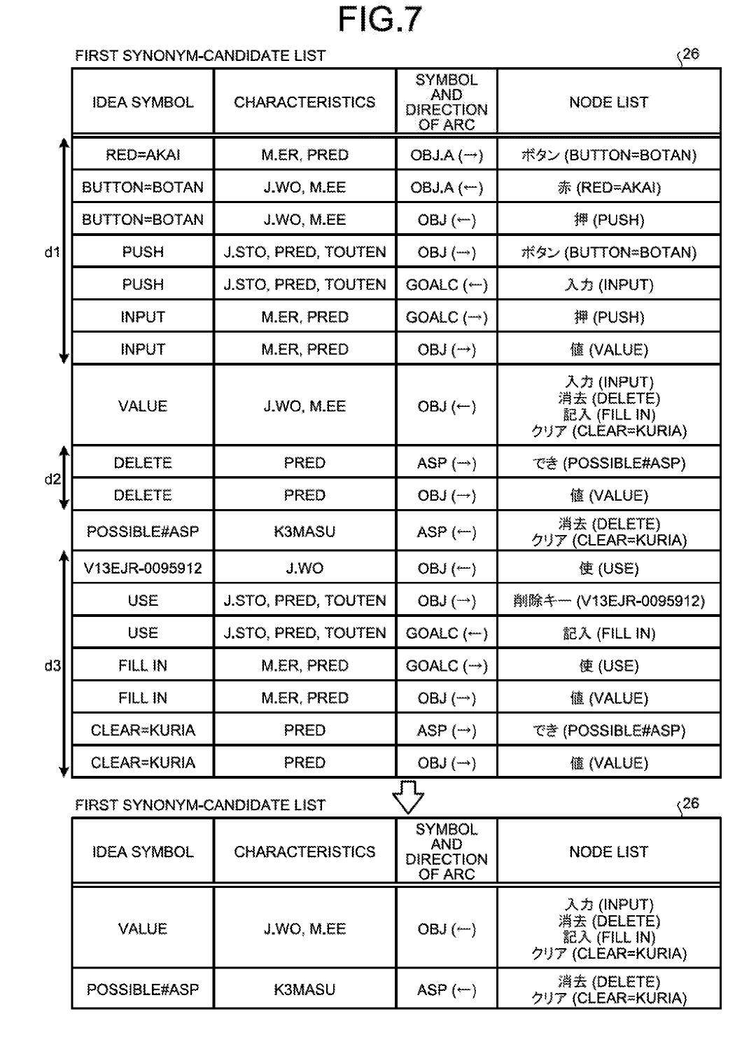

As illustrated in FIG. 7, the first synonym-candidate list 26 is represented. The first synonym-candidate extracting unit 131 refers to the generated characteristics list of each node and the idea structure 25 and adds, to the first synonym-candidate list 26, the partner node that is connected to the node that is represented by the idea symbol and the characteristics via the arc with the symbol. Here, for example, the node that is represented by the word “ [symbol] ” and the idea symbol “BUTTON=BOTAN” is added as the partner node that is connected to the node that is represented by the idea symbol “RED=AKAI” and the characteristics “M.ER, PRED” via the arc with the symbol and the direction “OBJ.A(→)”. Furthermore, the node that is represented by the word “ [symbol] ” and the idea symbol “INPUT” is added as the partner node that is connected to the node that is represented by the idea symbol “VALUE” and the characteristics “J.WO, M.EE” via the arc with the symbol and the direction “OBJ(←)”. Moreover, the node that is represented by the word “ [symbol] ” and the idea symbol “DELETE” is added as the partner node that is connected to the node that is represented by the idea symbol “VALUE” and the characteristics “J.WO, M.EE” via the arc with the symbol and the direction “OBJ(←)”. As a result, the first synonym-candidate list 26 in the upper section of FIG. 7 is generated.

Here, hash may be used for addition of the partner node. Specifically, when the partner node, which is connected to a specific node, is added, the first synonym-candidate extracting unit 131 calculates the hash value by using the hash function based on the idea symbol and the characteristics of the specific node and the symbol and the direction of the arc. If the calculated hash value does not exist yet, the first synonym-candidate extracting unit 131 relates the hash value to the synonym candidate list, sets the idea symbol and the characteristics of the specific node and the symbol of the arc in the synonym candidate list, and adds the partner node in the node list. If the calculated hash value has already existed, the first synonym-candidate extracting unit 131 adds the partner node to the node list in the synonym candidate list that is related to the hash value. Thus, the first synonym-candidate extracting unit 131 may retrieve the position to which the partner node is to be added at a high speed and may generate the first synonym-candidate list 26 at a high speed.

Then, from the generated first synonym-candidate list 26, the first synonym-candidate extracting unit 131 deletes the row that has only one node registered in the node list. Then, in the first synonym-candidate list 26, the nodes that remain in the node list are synonym candidates. Here, the row that is indicated by the reference numeral d1, the row that is indicated by the reference numeral d2, and the row that is indicated by the reference numeral d3 are deleted. As a result, with regard to the idea symbol “VALUE” and the characteristics “J.WO, M.EE”, the nodes included in the node list are synonym candidates. That is, the nodes, which are the node of the word “ [symbol] ”, the node of the word “ [symbol] ”, the node of the word “ [symbol] ”, and the node of the word “ [symbol] ” are synonym candidates. With regard to the idea symbol “POSSIBLE#ASP” and the characteristics “K3MASU”, the nodes included in the node list are synonym candidates. That is, the nodes, which are the node of the word “ [symbol] ” and the node of the word “ [symbol] ”, are synonym candidates. Thus, the first synonym-candidate list 26, illustrated in the lower section of FIG. 7, is a generated result.

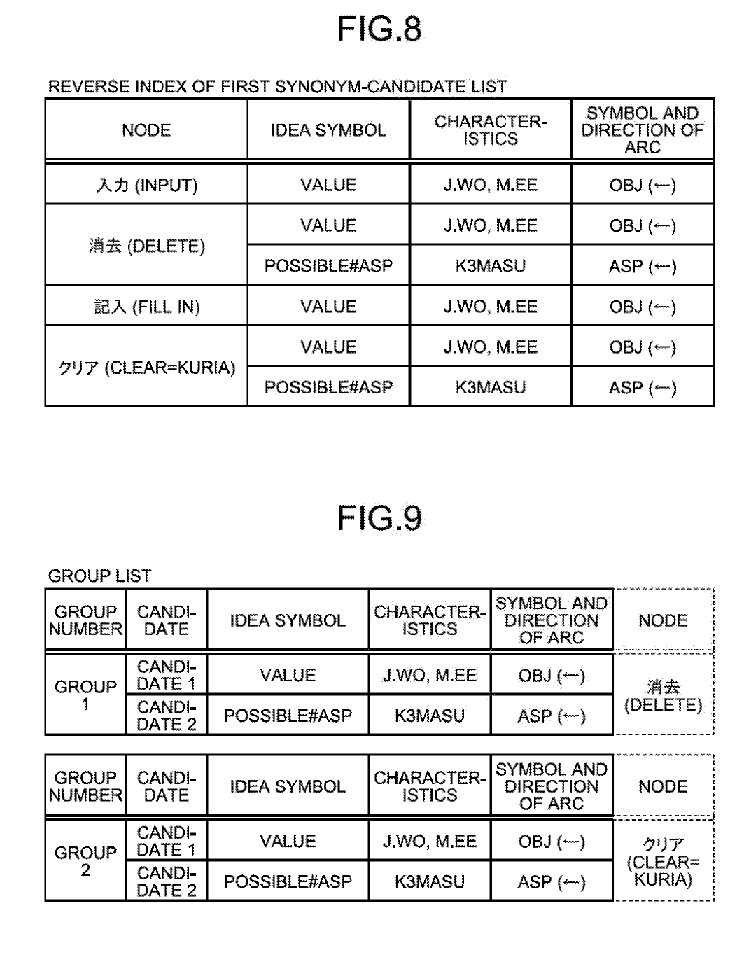

FIGS. 8 to 10 are diagrams that illustrate an example of a second synonym-candidate extraction process according to the embodiment.

As illustrated in FIG. 8, the reverse index of the first synonym-candidate list 26 is represented. The second synonym-candidate extracting unit 132 generates the reverse index that traces in reverse from each node, registered in the node list of the first synonym-candidate list 26, to the idea symbol. Here, for example, in the node list of the first synonym-candidate list 26, the node of the word “ [symbol] ”, the node of the word “ [symbol] ”, the node of the word “ [symbol] ”, and the node of the word “ [symbol] ” are registered. The second synonym-candidate extracting unit 132 fetches the row that corresponds to the node of the word “ [symbol] ” from the first synonym-candidate list 26. Then, the second synonym-candidate extracting unit 132 adds the idea symbol “VALUE”, the characteristics “J.WO, M.EE”, and the symbol and the direction “OBJ(←)” of the arc in the fetched row in relation to the node of the word “ [symbol] ” In the same manner, the second synonym-candidate extracting unit 132 fetches the row that corresponds to the node of the word “ [symbol] ” from the first synonym-candidate list 26. Then, the second synonym-candidate extracting unit 132 adds the idea symbol “VALUE”, the characteristics “J.WO, M.EE”, and the symbol and the direction “OBJ(←)” of the arc in the fetched row in relation to the node of the word “ [symbol] ”.

As illustrated in FIG. 9, a pair list is represented. The second synonym-candidate extracting unit 132 uses the first synonym-candidate list 26 and the reverse index of the first synonym-candidate list 26 to extract two rows that include the same node as a pair. Here, the node of the word “ [symbol] ” is included in two rows. Therefore, with regard to the node of the word “ [symbol] ”, the second synonym-candidate extracting unit 132 extracts two rows as a pair. The pair number is a pair 1. The node of the word “ [symbol] ” is included in two rows. Therefore, the second synonym-candidate extracting unit 132 extracts two rows as a pair with regard to the node of the word “ [symbol] ”. The pair number is a pair 2.

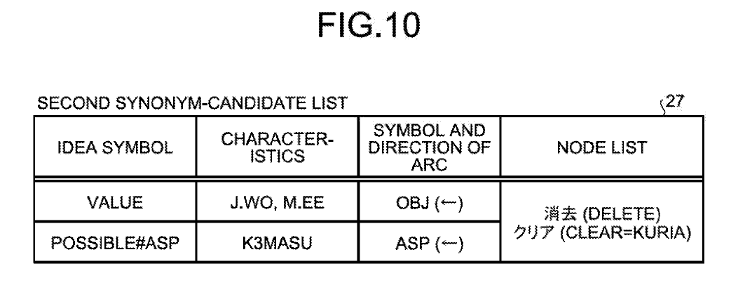

As illustrated in FIG. 10, the second synonym-candidate list 27 is represented. The second synonym-candidate extracting unit 132 fetches two pairs that have the same relationship from the extracted pairs and determines that the two nodes, included in each of the fetched two pairs, are synonym candidates. Here, the extracted two pairs, i.e., the pair 1 and the pair 2, have the same idea symbol, characteristics, and symbol and direction of the arc, they have the same relationship. Therefore, the second synonym-candidate extracting unit 132 determines that the two nodes included in each of the extracted two pairs, the pair 1 and the pair 2, are synonym candidates. Specifically, the node of the word “ [symbol] ” and the node of the word “ [symbol] ” are synonym candidates. Specifically, if the row with the idea symbol “VALUE” and the row with the idea symbol “POSSIBLE#ASP” are combined, the same node is registered in the node list, and “ [symbol] ” and “ [symbol] ” are synonym candidates. The second synonym-candidate list 27, illustrated in FIG. 10, is a generated result.

Flowchart of the First Synonym-Candidate Extraction Process

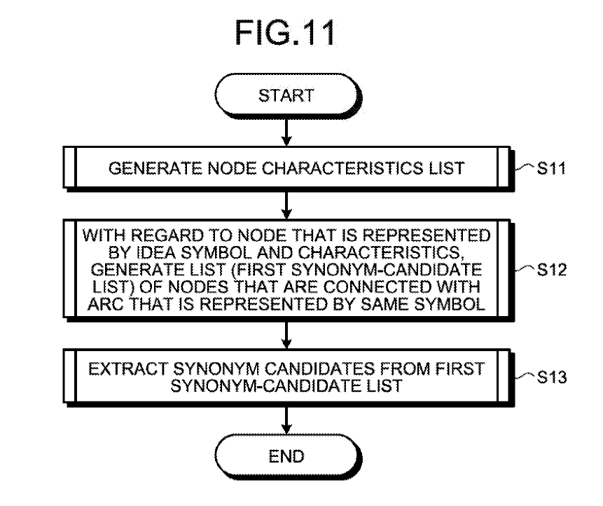

FIGS. 11 to 14 and FIG. 16 are diagrams that illustrate an example of the flowchart of the first synonym-candidate extraction process according to the embodiment.

As illustrated in FIG. 11, the first synonym-candidate extracting unit 131 generates the node characteristics list (Step S11). Furthermore, the flowchart of the process to generate the node characteristics list is described later.

With regard to the node that is represented by the idea symbol and the characteristics, the first synonym-candidate extracting unit 131 generates the list of nodes that are connected with the arc that is represented by the same symbol (Step S12). That is, the first synonym-candidate extracting unit 131 generates the first synonym-candidate list 26. Furthermore, the flowchart of the process to generate the first synonym-candidate list 26 is described later.

The first synonym-candidate extracting unit 131 extracts synonym candidates from the first synonym-candidate list 26 (Step S13). Furthermore, the flowchart of the synonym-candidate extraction process is described later. Then, after a synonym candidate is extracted, the first synonym-candidate extracting unit 131 terminates the first synonym-candidate extraction process.

Flowchart of the Process to Generate the Node Characteristics List

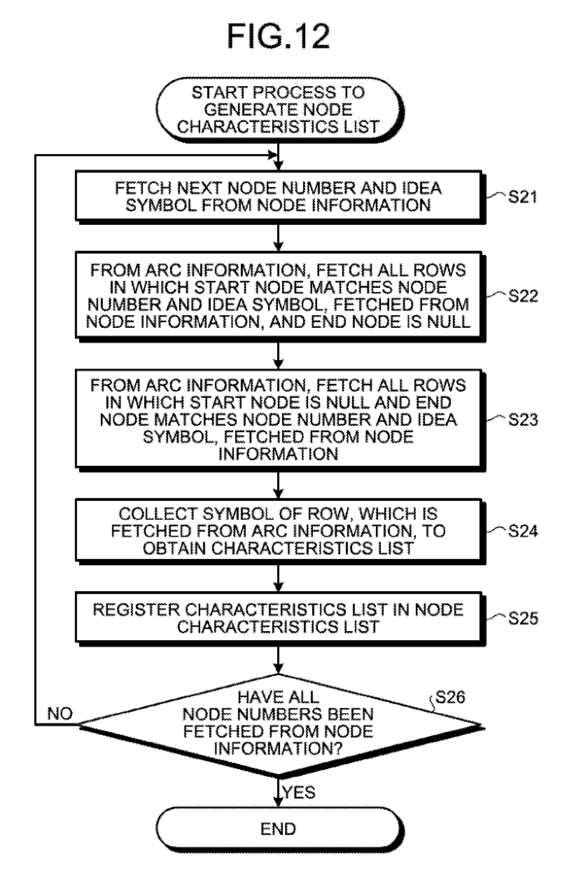

FIG. 12 is a diagram that illustrates an example of the flowchart of the process to generate the node characteristics list. As illustrated in FIG. 12, the first synonym-candidate extracting unit 131 fetches the next node number and the idea symbol from the node information in the idea structure 25 (Step S21).

From the arc information in the idea structure 25, the first synonym-candidate extracting unit 131 fetches all the rows in which the start node matches the node number and the idea symbol, fetched from the node information, and the end node is NULL (Step S22). From the arc information in the idea structure 25, the first synonym-candidate extracting unit 131 fetches all the rows in which the start node is NULL and the end node matches the node number and the idea symbol, fetched from the node information (Step S23).

Then, the first synonym-candidate extracting unit 131 collects the symbol of the row, which is fetched from the arc information in the idea structure 25, with regard to each node number and idea symbol to obtain the characteristics list (Step S24). The first synonym-candidate extracting unit 131 registers the characteristics list in the node characteristics list (Step S25).

The first synonym-candidate extracting unit 131 determines whether all the node numbers have been fetched from the node information (Step S26). If all the node numbers have not been fetched (Step S26; No), the first synonym-candidate extracting unit 131 proceeds to Step S21 to fetch the next node number.

Conversely, if all the node numbers have been fetched (Step S26; Yes), the first synonym-candidate extracting unit 131 terminates the process to generate the node characteristics list.

Flowchart of the Process to Generate the First Synonym-Candidate List

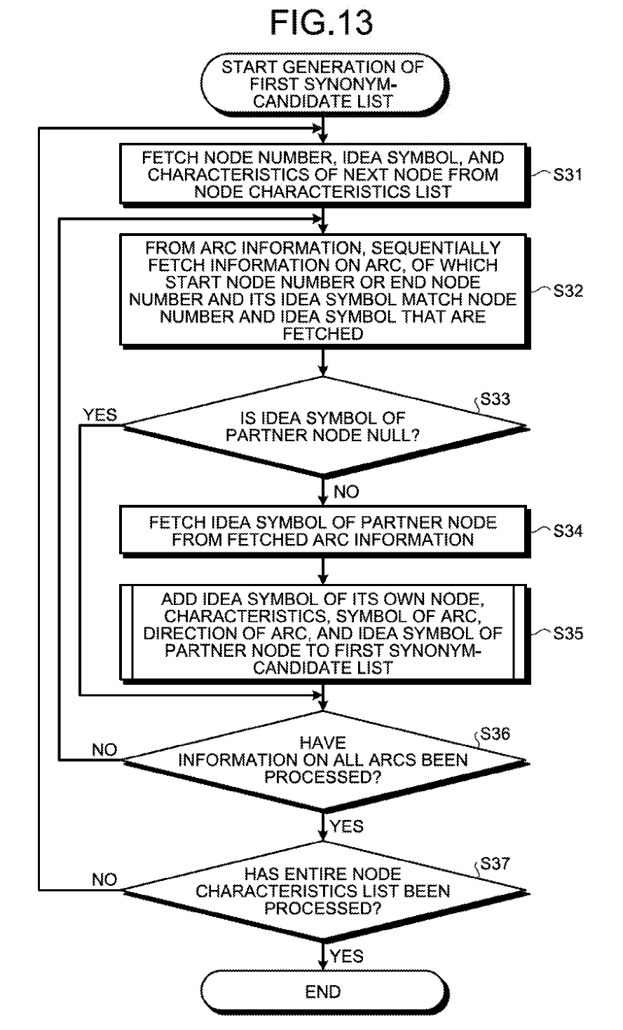

FIG. 13 is a diagram that illustrates an example of the flowchart of the process to generate the first synonym-candidate list. As illustrated in FIG. 13, the first synonym-candidate extracting unit 131 fetches the node number, the idea symbol, and the characteristics of the next node from the node characteristics list (Step S31).

From the arc information in the idea structure 25, the first synonym-candidate extracting unit 131 sequentially fetches the information on the arc, of which the start node number or the end node number and the idea symbol match the node number and the idea symbol that are fetched (Step S32).

The first synonym-candidate extracting unit 131 determines whether the idea symbol of the partner node is NULL (Step S33). If it is determined that the idea symbol of the partner node is NULL (Step S33; Yes), the first synonym-candidate extracting unit 131 proceeds to Step S36.

Conversely, if it is determined that the idea symbol of the partner node is not NULL (Step S33; No), the first synonym-candidate extracting unit 131 fetches the idea symbol of the partner node from the fetched arc information (Step S34). The first synonym-candidate extracting unit 131 adds the idea symbol of its own node, the characteristics, the symbol of the arc, the direction of the arc, and the idea symbol of the partner node to the first synonym-candidate list 26 (Step S35). Then, the first synonym-candidate extracting unit 131 proceeds to Step S36. Furthermore, the flowchart of the process for addition to the first synonym-candidate list 26 is described later.

At Step S36, the first synonym-candidate extracting unit 131 determines whether the information on all the arcs has been processed (Step S36). If it is determined that the information on all the arcs has not been processed (Step S36; No), the first synonym-candidate extracting unit 131 proceeds to Step S32 to fetch the information on the next arc from the arc information in the idea structure 25.

Conversely, if it is determined that the information on all the arcs has been processed (Step S36; Yes), the first synonym-candidate extracting unit 131 determines whether the entire node characteristics list. has been processed (Step S37). If it is determined that the entire node characteristics list has not been processed (Step S37; No), the first synonym-candidate extracting unit 131 proceeds to Step S31 to fetch the information on the next node from the node characteristics list.

Conversely, if it is determined that the entire node characteristics list has been processed (Step S37; Yes), the first synonym-candidate extracting unit 131 terminates the process to generate the first synonym-candidate list.

Flowchart of the Process for Addition to the First Synonym-Candidate List

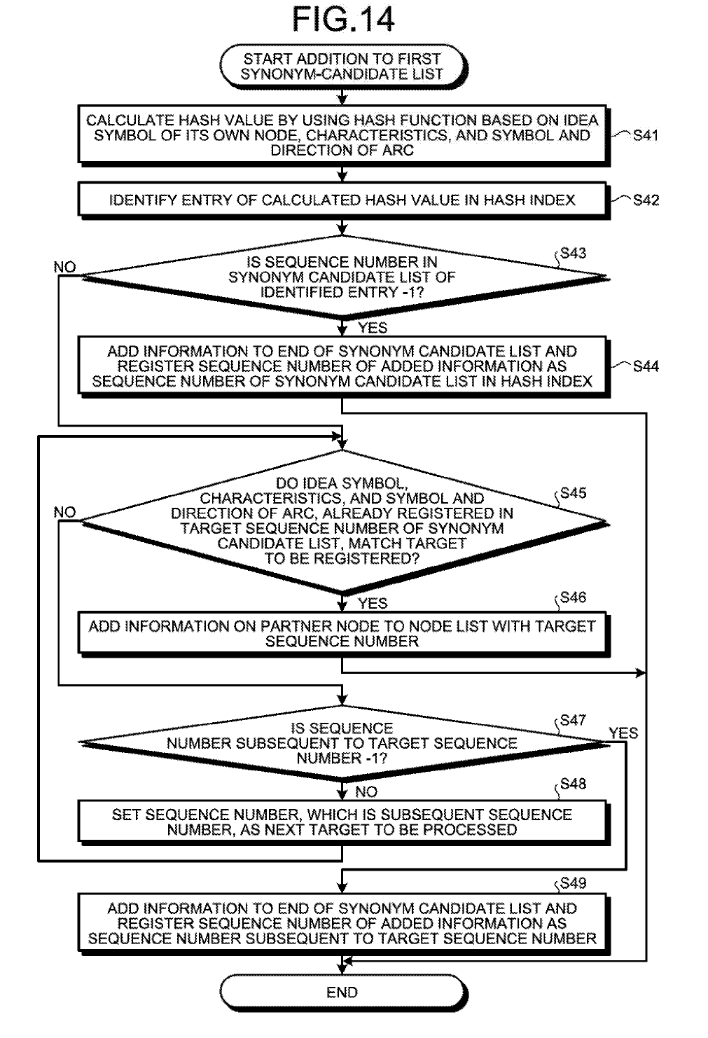

FIG. 14 is a diagram that illustrates an example of the flowchart of the process for addition to the first synonym-candidate list. As illustrated in FIG. 14, the first synonym-candidate extracting unit 131 calculates the hash value by using the hash function based on the idea symbol of its own node, the characteristics, and the symbol and the direction of the arc (Step S41). The first synonym-candidate extracting unit 131 identifies the entry of the calculated hash value in the hash index (Step S42).

The first synonym-candidate extracting unit 131 determines whether the sequence number of the identified entry in the synonym candidate list is −1 (not registered in the synonym candidate list) (Step S43). If it is determined that the sequence number of the identified entry in the synonym candidate list is −1 (Step S43; Yes), the first synonym-candidate extracting unit 131 adds the idea symbol of its own node, the characteristics, the symbol of the arc, the direction of the arc, and the idea symbol of the partner node to the end of the synonym candidate list. Then, the first synonym-candidate extracting unit 131 registers the sequence number of the added information in the synonym candidate list as the sequence number of the synonym candidate list in the hash index (Step S44). Then, the first synonym-candidate extracting unit 131 terminates the process for addition to the first synonym-candidate list 26.

Conversely, if it is determined that the sequence number of the identified entry in the synonym candidate list is not −1 (Step S43; No), the first synonym-candidate extracting unit 131 performs the following operation. Specifically, the first synonym-candidate extracting unit 131 determines whether the idea symbol, the characteristics, and the symbol and the direction of the arc, already registered in the target sequence number of the synonym candidate list, match the target to be registered (Step S45).

If it is determined that the idea symbol, the characteristics, and the symbol and the direction of the arc, already registered in the target sequence number of the synonym candidate list, match the target to be registered (Step S45; Yes), the first synonym-candidate extracting unit 131 performs the following operation. Specifically, the first synonym-candidate extracting unit 131 adds the information on the partner node to the node list with the target sequence number (Step S46). Then, the first synonym-candidate extracting unit 131 terminates the process for addition to the first synonym-candidate list 26.

Conversely, if it is determined that the idea symbol, the characteristics, and the symbol and the direction of the arc, already registered in the target sequence number of the synonym candidate list, do not match the target to be registered (Step S45; No), a synonym is generated, and the first synonym-candidate extracting unit 131 performs the following operation. Specifically, the first synonym-candidate extracting unit 131 determines whether the sequence number subsequent to the target sequence number is −1 (Step S47).

If it is determined that the sequence number subsequent to the target sequence number is not −1 (Step S47; No), the first synonym-candidate extracting unit 131 sets the sequence number, which is the subsequent sequence number, as the next target to be processed (Step S48). Then, the first synonym-candidate extracting unit 131 proceeds to Step S45.

Conversely, if it is determined that the sequence number subsequent to the target sequence number is −1 (Step S47; Yes), the first synonym-candidate extracting unit 131 adds the idea symbol of its own node, the characteristics, the symbol of the arc, the direction of the arc, and the idea symbol of the partner node to the end of the synonym candidate list. Then, the first synonym-candidate extracting unit 131 registers the sequence number of the added information in the synonym candidate list as the sequence number subsequent to the target sequence number (Step S49). Then, the first synonym-candidate extracting unit 131 terminates the process for addition to the first synonym-candidate list 26.

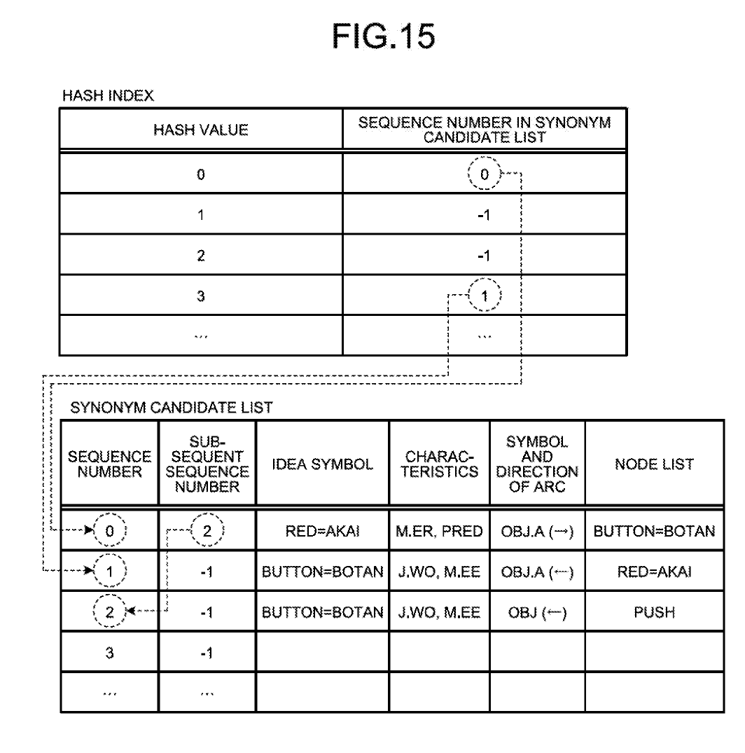

Here, with reference to FIG. 15, an explanation is given of the data structures of the hash index and the synonym candidate list, which are used in the flowchart of FIG. 14. FIG. 15 is a diagram that illustrates an example of the data structures of the hash index and the synonym candidate list.

The hash index is illustrated in the upper section of FIG. 15. The hash index is the sequence in which hash values are provided as indexes. The hash index relates the hash value with the sequence number in the synonym candidate list. If the sequence number in the synonym candidate list is not −1, it refers to the synonym candidate list that has the corresponding hash value. If the sequence number in the synonym candidate list is −1, it indicates that the information on the synonym candidate, which has the corresponding hash value, is not registered.

The synonym candidate list is illustrated in the lower section of FIG. 15. The synonym candidate list corresponds to the first synonym-candidate list 26. The synonym candidate list relates the sequence number, the subsequent sequence number, the idea symbol, the characteristics, the symbol and the direction of the arc, and the node list. The sequence number is related to the sequence number of the synonym candidate list in the hash index. If the subsequent sequence number is not −1, the subsequent sequence number indicates the number of the information on another synonym candidate that has the same hash value. Specifically, if a synonym is generated, another sequence number is set as the subsequent sequence number. If the subsequent sequence number is −1, it indicates that there is no more information on the synonym candidate that has the same hash.

Flowchart of the Synonym-Candidate Extraction Process

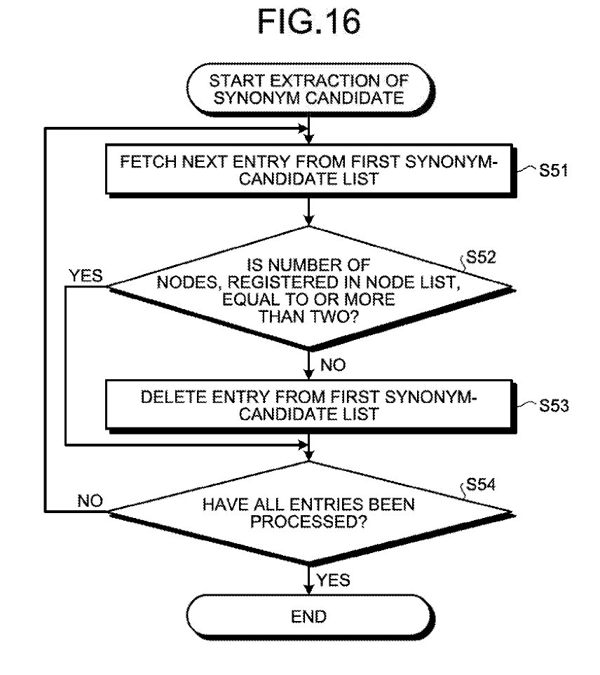

FIG. 16 is a diagram that illustrates an example of the flowchart of the synonym-candidate extraction process. As illustrated in FIG. 16, the first synonym-candidate extracting unit 131 fetches the next entry (row) from the first synonym-candidate list 26 (Step S51). The first synonym-candidate extracting unit 131 determines whether the number of nodes, registered in the node list of the first synonym-candidate list 26, is equal to or more than two (Step S52).

If it is determined that the number of nodes, registered in the node list, is not equal to or more than two (Step S52; No), the first synonym-candidate extracting unit 131 deletes the entry from the first synonym-candidate list 26 (Step S53). Then, the first synonym-candidate extracting unit 131 proceeds to Step S54.

Conversely, if it is determined that the number of nodes, registered in the node list, is equal to or more than two (Step S52; Yes), the first synonym-candidate extracting unit 131 determines that the registered nodes are synonym candidates and proceeds to Step S54.

At Step S54, the first synonym-candidate extracting unit 131 determines whether all the entries in the first synonym-candidate list 26 have been processed (Step S54). If it is determined that all the entries have not been processed (Step S54; No), the first synonym-candidate extracting unit 131 proceeds to Step S51 to process the next entry.

Conversely, if it is determined that all the entries have been processed (Step S54; Yes), the first synonym-candidate extracting unit 131 terminates the first synonym-candidate extraction process.

Flowchart of the Second Synonym-Candidate Extraction Process

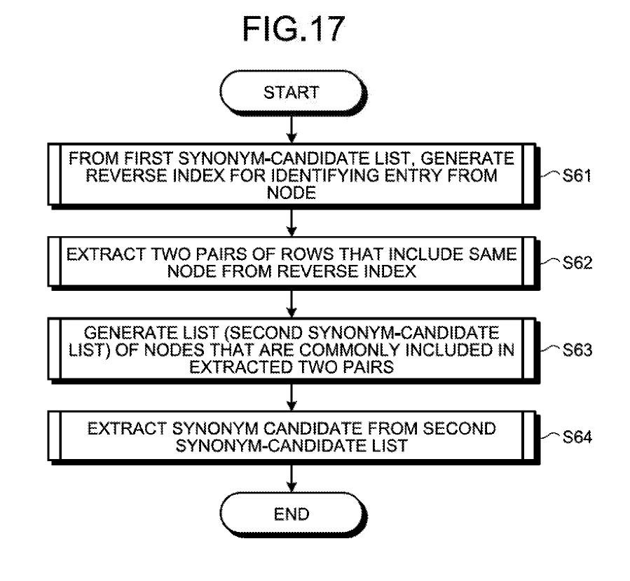

FIGS. 17 to 21 are diagrams that illustrate an example of the flowchart of the second synonym-candidate extraction process according to the embodiment.

As illustrated in FIG. 17, from the first synonym-candidate list 26, the second synonym-candidate extracting unit 132 generates the reverse index for identifying the entry (row) from the node in the node list (Step S61). Furthermore, the flowchart of the process to generate the reverse index is described later.

From the reverse index, the second synonym-candidate extracting unit 132 extracts two pairs of rows that include the same node (Step S62). Furthermore, the flowchart of the process to extract two pairs of rows that include the same node is described later.

The second synonym-candidate extracting unit 132 generates the list of nodes that are commonly included in the extracted two pairs (Step S63). Specifically, the second synonym-candidate extracting unit 132 generates the second synonym-candidate list 27. Furthermore, the flowchart of the process to generate the list of commonly included nodes is described later.

The second synonym-candidate extracting unit 132 extracts a synonym candidate from the second synonym-candidate list 27 (Step S64). Furthermore, the flowchart of the synonym-candidate extraction process is described later. Then, the second synonym-candidate extracting unit 132 terminates the second synonym-candidate extraction process.

Flowchart of the Reverse-Index Generation Process

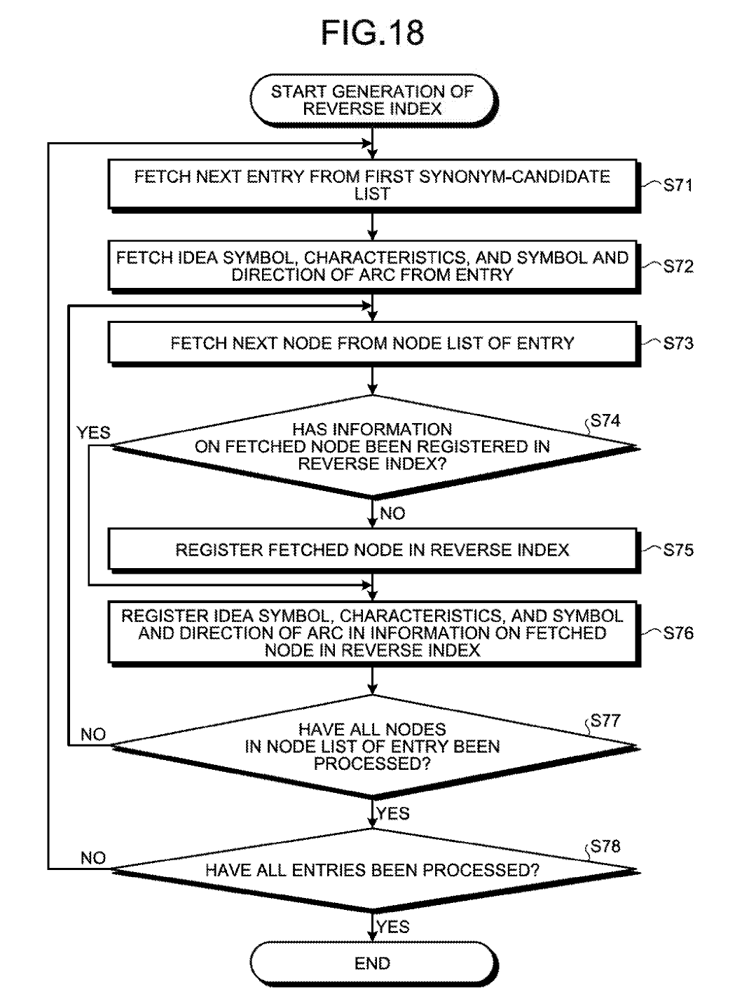

FIG. 18 is a diagram that illustrates an example of the flowchart of the process to generate the reverse index. As illustrated in FIG. 18, the second synonym-candidate extracting unit 132 fetches the next entry (row) from the first synonym-candidate list 26 (Step S71). The second synonym-candidate extracting unit 132 fetches the idea symbol, the characteristics, and the symbol and the direction of the arc from the fetched entry (Step S72).

Then, the second synonym-candidate extracting unit 132 fetches the next node from the node list of the entry (Step S73). The second synonym-candidate extracting unit 132 determines whether the information on the fetched node has been registered in the reverse index (Step S74). If it is determined that the information on the fetched node has been registered (Step S74; Yes), the second synonym-candidate extracting unit 132 proceeds to Step S76.

Conversely, if it is determined that the information on the fetched node has not been registered (Step S74; No), the second synonym-candidate extracting unit 132 registers the fetched node in the reverse index (Step S75). Then, the second synonym-candidate extracting unit 132 proceeds to Step S76.

At Step S76, the second synonym-candidate extracting unit 132 registers the idea symbol, the characteristics, the symbol and the direction of the arc in the information on the fetched node in the reverse index (Step S76).

The second synonym-candidate extracting unit 132 determines whether all the nodes in the node list of the entry have been processed (Step S77). If it is determined that all the nodes in the node list of the entry have not been processed (Step S77; No), the second synonym-candidate extracting unit 132 proceeds to Step S73 to process the next node.

Conversely, If it is determined that all the nodes in the node list of the entry have been processed (Step S77; Yes), the second synonym-candidate extracting unit 132 determines whether all the entries in the first synonym-candidate list 26 have been processed (Step S78). If it is determined that all the entries have not been processed (Step S78; No), the second synonym-candidate extracting unit 132 proceeds to Step S71 to fetch the next entry.

Conversely, if it is determined that all the entries have been processed (Step S78; Yes), the second synonym-candidate extracting unit 132 terminates the process to generate the reverse index.

Flowchart of the Process to Extract Two Pairs of Rows that Include the Same Node

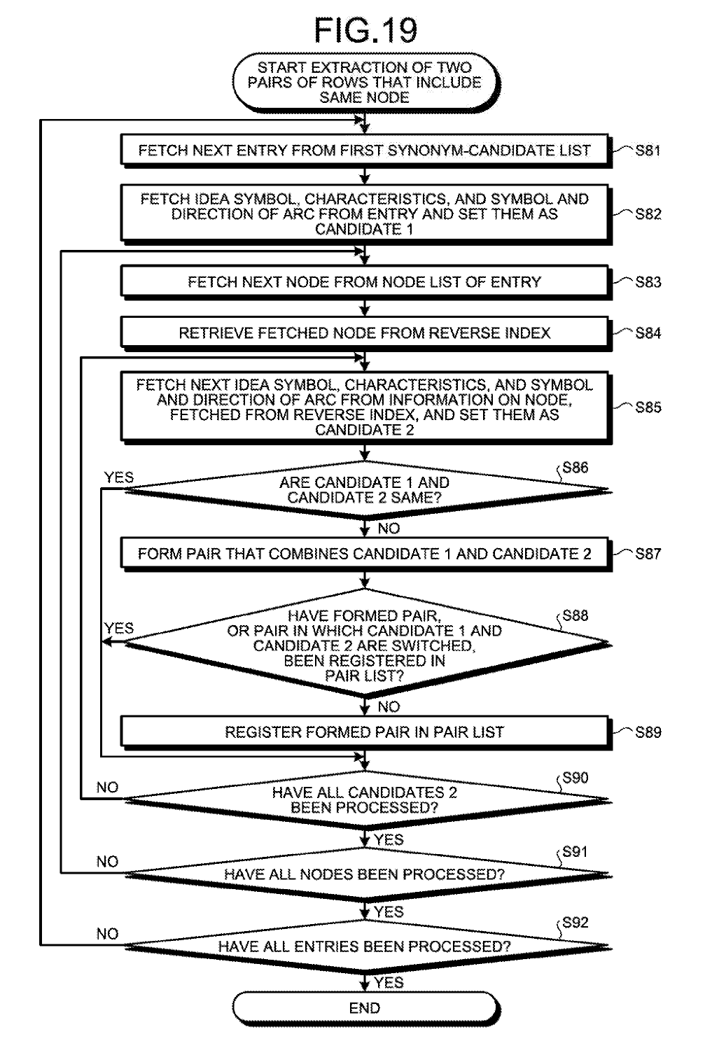

FIG. 19 is a diagram that illustrates an example of the flowchart of the process to extract two pairs of rows that include the same node. As illustrated in FIG. 19, the second synonym-candidate extracting unit 132 fetches the next entry from the first synonym-candidate list 26 (Step S81). The second synonym-candidate extracting unit 132 fetches the idea symbol, the characteristics, the symbol and the direction of the arc from the fetched entry and sets the fetched information as a candidate 1 (Step S82).

The second synonym-candidate extracting unit 132 fetches the next node from the node list of the entry (Step S83). The second synonym-candidate extracting unit 132 retrieves the fetched node from the reverse index (Step S84). The second synonym-candidate extracting unit 132 fetches the next idea symbol, the characteristics, and the symbol and the direction of the arc from the information on the node, fetched from the reverse index, and sets the fetched information as a candidate 2 (Step S85).

The second synonym-candidate extracting unit 132 determines whether the candidate 1 and the candidate 2 are the same (Step S86). If it is determined that the candidate 1 and the candidate 2 are the same (Step S86; Yes), the candidate 1 and the candidate 2 do not form a pair, and therefore the second synonym-candidate extracting unit 132 proceeds to Step S90.

Conversely, if it is determined that the candidate 1 and the candidate 2 are not the same (Step S86; No), the second synonym-candidate extracting unit 132 forms a pair that combines the candidate 1 and the candidate 2 (Step S87). The second synonym-candidate extracting unit 132 determines whether the formed pair, or the pair in which the candidate 1 and the candidate 2 are switched, has been registered in the pair list (Step S88).

If it is determined that the formed pair, or the pair in which the candidate 1 and the candidate 2 are switched, has been registered in the pair list (Step S88; Yes), the same pair is already present, and therefore the second synonym-candidate extracting unit 132 proceeds to Step S90. Conversely, if it is determined that the formed pair, or the pair in which the candidate 1 and the candidate 2 are switched, has not been registered in the pair list (Step S88; No), the second synonym-candidate extracting unit 132 registers the formed pair in the pair list (Step S89).

At Step S90, the second synonym-candidate extracting unit 132 determines whether all the candidates 2 have been processed (Step S90). If it is determined that all the candidates 2 have not been processed (Step S90; No), the second synonym-candidate extracting unit 132 proceeds to Step S85 to process the next candidate 2.

Conversely, if it is determined that all the candidates 2 have been processed (Step S90; Yes), the second synonym-candidate extracting unit 132 determines whether all the nodes have been processed (Step S91). If it is determined that all the nodes have not been processed (Step S91; No), the second synonym-candidate extracting unit 132 proceeds to Step S83 to process the next node.

Conversely, if it is determined that all the nodes have been processed (Step S91; Yes), the second synonym-candidate extracting unit 132 determines whether all the entries have been processed (Step S92). If it is determined that all the entries have not been processed (Step S92; No), the second synonym-candidate extracting unit 132 proceeds to Step S81 to process the next entry.

Conversely, if it is determined that all the entries have been processed (Step S92; Yes), the second synonym-candidate extracting unit 132 terminates the process to extract two pairs of rows that include the same node.

Flowchart of the Process to Generate the List of Commonly Included Nodes

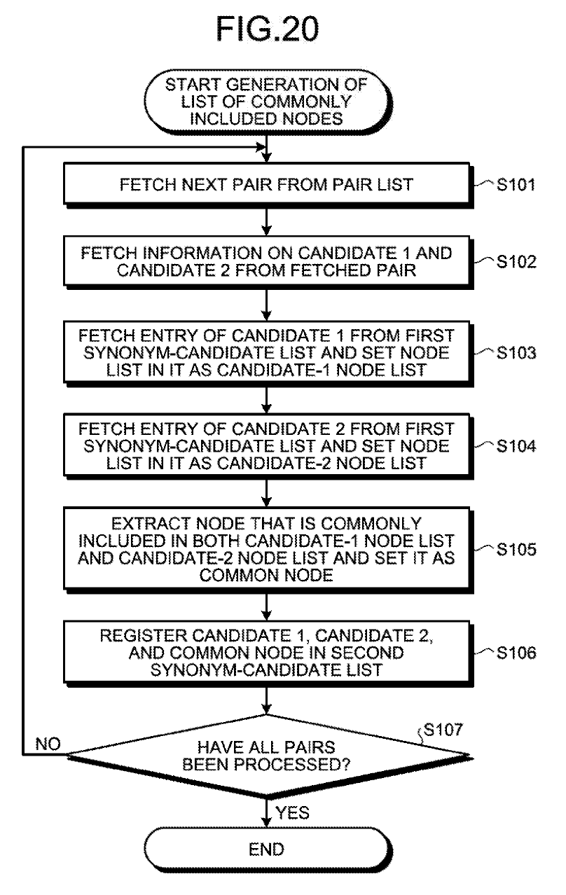

FIG. 20 is a diagram that illustrates an example of the flowchart of the process to generate the list of commonly included nodes. As illustrated in FIG. 20, the second synonym-candidate extracting unit 132 fetches the next pair from the pair list (Step S101). The second synonym-candidate extracting unit 132 fetches the information on the candidate 1 and the candidate 2 from the fetched pair (Step S102). Specifically, the second synonym-candidate extracting unit 132 fetches the idea symbol of the candidate 1, the characteristics, and the symbol and the direction of the arc and the idea symbol of the candidate 2, the characteristics, and the symbol and the direction of the arc.

The second synonym-candidate extracting unit 132 fetches the entry of the candidate 1 from the first synonym-candidate list 26 and sets the node list, included in the fetched entry, as a candidate-1 node list (Step S103). The second synonym-candidate extracting unit 132 fetches the entry of the candidate 2 from the first synonym-candidate list 26 and sets the node list, included in the fetched entry, as a candidate-2 node list (Step S104).

The second synonym-candidate extracting unit 132 extracts a node that is commonly included in both the candidate-1 node list and the candidate-2 node list and sets the extracted node as the common node (Step S105). For example, if two nodes, which have the information on the candidate 1, and two nodes, which have the information on the candidate 2, are common, the two nodes are common nodes.

Then, the second synonym-candidate extracting unit 132 registers the candidate 1, the candidate 2, and the common node in the second synonym-candidate list 27 (Step S106). The second synonym-candidate extracting unit 132 determines whether all the pairs have been processed (Step S107). If it is determined that all the pairs have not been processed (Step S107; No), the second synonym-candidate extracting unit 132 proceeds to Step S101 to process the next pair.

Conversely, if it is determined that all the pairs have been processed (Step S107; Yes), the second synonym-candidate extracting unit 132 terminates the process to generate the list of commonly included nodes.

Flowchart of the Synonym-Candidate Extraction Process

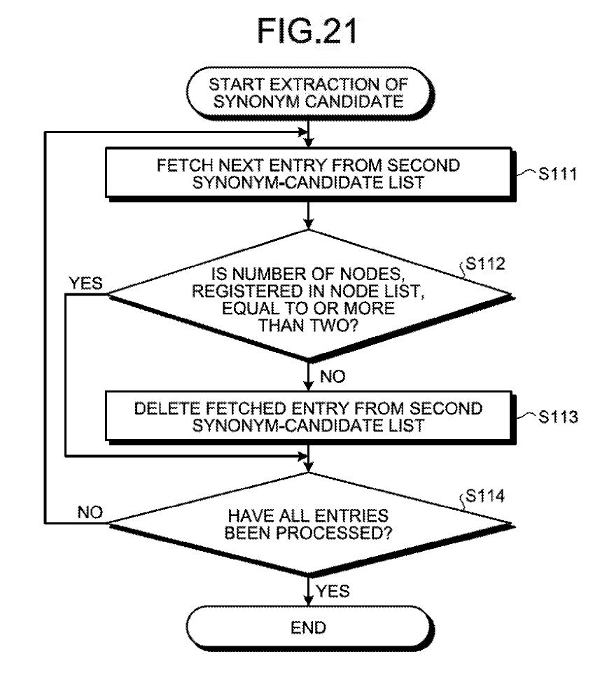

FIG. 21 is a diagram that illustrates an example of the flowchart of the synonym-candidate extraction process. As illustrated in FIG. 21, the second synonym-candidate extracting unit 132 fetches the next entry from the second synonym-candidate list 27 (Step S111). The second synonym-candidate extracting unit 132 determines whether the number of nodes, registered in the node list that is included in the entry, is equal to or more than two (Step S112).

If it is determined that the number of nodes, registered in the node list, is not equal to or more than two (Step S112; No), the second synonym-candidate extracting unit 132 deletes the fetched entry from the second synonym-candidate list 27 (Step S113). Then, the second synonym-candidate extracting unit 132 proceeds to Step S114.

Conversely, if it is determined that the number of nodes, registered in the node list, is equal to or more than two (Step S112; Yes), the second synonym-candidate extracting unit 132 proceeds to Step S114.

At Step S114, the second synonym-candidate extracting unit 132 determines whether all the entries have been processed (Step S114). If it is determined that all the entries have not been processed (Step S114; No), the second synonym-candidate extracting unit 132 proceeds to Step S111 to process the next entry.

Conversely, if it is determined that all the entries have been processed (Step S114; Yes), the second synonym-candidate extracting unit 132 terminates the synonym-candidate extraction process.

### Advantages of the Embodiment

As described above, the information processing device 1 receives sentence data, performs a semantic analysis process on multiple words, included in the received sentence data and, with regard to each of the words, generates the idea structure 25 that indicates the relationship with a different word among the words. The information processing device 1 makes determinations with regard to the similarity between words on the basis of the similarity of the generated idea structure 25. Then, the information processing device 1 outputs a result of the determination. With this configuration, the information processing device 1 may reduce the processing loads for determination on the similarity between words.

Furthermore, with regard to each word included in the words, the information processing device 1 generates the idea structure 25 that represents the idea symbol, which indicates the idea that is possessed by the word, the relationship symbol, which indicates the relationship between the word and a different word included in the words, and the direction of the relationship. With this configuration, the information processing device 1 uses the idea structure 25 to be able to automatically determine the similarity between words.

Furthermore, the information processing device 1 determines whether the word with the idea symbol, included in the idea structure 25, is connected to a different word included in the words with the same relationship symbol and in the same direction of the relationship, thereby determining the similarity between the words. As a result of the determination, the information processing device 1 outputs the list of different words, which are connected with the same relationship symbol and in the same direction of the relationship, to the first synonym-candidate list 26. With this configuration, even if the target document is a document that is specialized in the contents, the information processing device 1 may automatically generate the synonym dictionary of the document as the first synonym-candidate list 26.

Furthermore, the information processing device 1 applies a specific hash function to the idea symbol that is possessed by the word, the relationship symbol that is possessed by the word, and the direction of the relationship to calculate a hash value. The information processing device 1 adds a different word, which is connected to the word, to the first synonym-candidate list 26 in relation to the calculated hash value. Furthermore, the information processing device 1 deletes the entry with the hash value, where the number of added different words is one, from the first synonym-candidate list 26. With this configuration, the information processing device 1 uses the hash to be able to generate the first synonym-candidate list 26 at a high speed.

Furthermore, on the basis of the first synonym-candidate list 26, the information processing device 1 generates the reverse index that traces in reverse from a different word to the idea symbol of the original word. The information processing device 1 uses the first synonym-candidate list 26 and the reverse index to extract entries that include the common different word as a pair. Then, if extracted two pairs of entries have a common relationship, the information processing device 1 determines that different words in the two pairs of entries are synonym candidates. With this configuration, even if the target document is a document that is specialized in the contents, the information processing device 1 may generate the synonym dictionary of the document as the second synonym-candidate list 27 that is more accurate than the first synonym-candidate list 26.

Others

Furthermore, components of the illustrated information processing device 1 do not always need to be physically configured as illustrated in the drawings. Specifically, specific forms of separation and combination of the information processing device 1 are not limited to those depicted in the drawings, and a configuration may be such that all or some of them are functionally or physically separated or combined in an arbitrary unit depending on various types of loads or usage. For example, the first synonym-candidate extracting unit 131 and the second synonym-candidate extracting unit 132 may be combined as a single unit. Furthermore, the storage unit 20 may be connected as an external device for the information processing device 1 via a network.

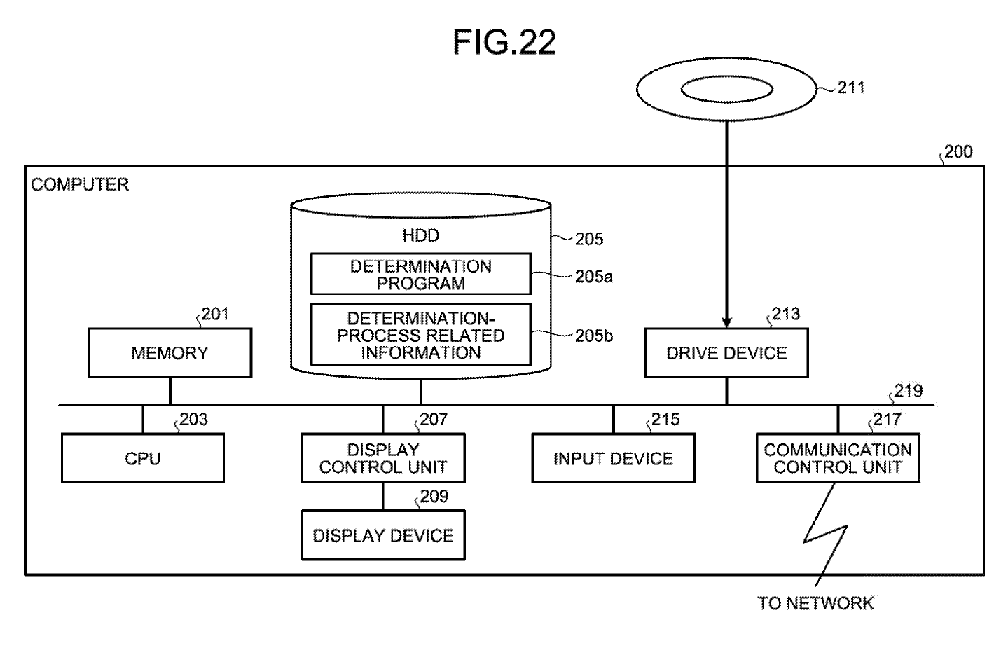

Furthermore, the various processes that are described in the above embodiment may be performed if prepared programs are performed by a computer, such as a personal computer or workstation. In the following, an explanation is given of an example of a computer that performs a determination program that performs the same functionality as that of the information processing device 1 illustrated in FIG. 1. FIG. 22 is a diagram that illustrates an example of the computer that executes the determination program.

As illustrated in FIG. 22, a computer 200 includes a CPU 203 that performs various types of arithmetic processing, an input device 215 that receives an input of data from users, and a display control unit 207 that controls a display device 209. Furthermore, the computer 200 includes a drive device 213 that reads programs, or the like, from a storage medium, and a communication control unit 217 that transfers and receives data to and from a different computer via a network. Furthermore, the computer 200 includes a memory 201 that temporarily stores various types of information and an HDD 205. Moreover, the memory 201, the CPU 203, the HDD 205, the display control unit 207, the drive device 213, the input device 215, and the communication control unit 217 are connected via a bus 219.

The drive device 213 is a device for, for example, a removable disk 211. The HDD 205 stores a determination program 205a and determination-process related information 205b.

The CPU 203 reads the determination program 205a, loads it into the memory 201, and executes it as a process. The process corresponds to each functional unit of the information processing device 1. The determination-process related information 205b corresponds to the idea structure 25, the first synonym-candidate list 26, and the second synonym-candidate list 27. Furthermore, for example, the removable disk 211 stores various types of information, such as the determination program 205a.

Furthermore, the determination program 205a does not always need to be initially stored in the HDD 205. For example, the program is stored in a “portable physical medium”, such as a flexible disk (FD), CD-ROM, DVD disk, magnet-optical disk, or IC card, which is inserted into the computer 200. Moreover, the computer 200 may read the determination program 205a from the above and execute it.

According to an embodiment, it is possible to automatically generate a synonym dictionary that is specialized in the contents of the target document.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
receiving sentence data;
generating sets of information, each of the sets indicating a relationship between each of words included in the received sentence data and another word among the words by executing a semantic analysis process on the words;
determining a similarity between the words based on a similarity between the generated the sets of information; and
outputting a result of the determining.

2. The non-transitory computer-readable recording medium according to claim 1, wherein the generating includes, with regard to each word included in the words, generating idea information that indicates an idea symbol that represents an idea possessed by the word, a relationship symbol that represents a relationship between the word and a different word included in the words, and a direction of a corresponding relationship.

3. The non-transitory computer-readable recording medium according to claim 2, wherein
the determining includes determining a similarity between the words by making a determination as to whether a word with an idea symbol included in the idea information is connected to each of a plurality of different words included in the words with an identical relationship symbol and in an identical direction of a relationship, and
the outputting includes, as a result of the determination, outputting a list of different words that are connected with an identical relationship symbol to a first list information.

4. The non-transitory computer-readable recording medium according to claim 3, wherein
the determining includes
applying a specific hash function to an idea symbol that is possessed by the word, a relationship symbol that is possessed by the word, and a direction of a relationship to calculate a hash value;
adding, to the first list information, the different word that is connected to the word in relation to the hash value calculated; and
deleting an entry of a hash value, of which a number of the added different words is one, from the first list information.

5. The non-transitory computer-readable recording medium according to claim 4, the process further including:
generating, from the first list information, second list information that traces in reverse from the different word to an idea symbol of an original word;
extracting, as a pair, entries that include the different word that is identical by using the first list information and the second list information; and
when extracted two pairs of entries have a common relationship, determining that different words in the two pairs of entries are synonym candidates.

6. A determination device comprising:
a processor;
a memory, wherein the processor executes a process comprising:
receiving sentence data;
generating sets of information, each of the sets indicating a relationship between each of words included in the received sentence data and another word among the words by executing a semantic analysis process on the words;
determining a similarity between the words based on a similarity between the generated the sets of information; and
outputting a result of determining.

7. A determination method to be performed by a computer, the determination method comprising:
generating sets of information, each of the sets indicating a relationship between each of words included in the received sentence data and another word among the words by executing a semantic analysis process on the words using the processor;
determining a similarity between the words based on a similarity between the generated the sets of information using the processor; and
outputting a result of the determining using the processor.
